(19) United States
(12) Patent Application Publication
(10) Pub. No.: US 2021/0081549 A1
(43) Pub. Date: Mar. 18, 2021

(54) SYSTEMS AND METHODS FOR SHARING DATA ASSETS VIA A COMPUTER-IMPLEMENTED DATA TRUST

(71) Applicant: Sightline Innovation Inc., Toronto (CA)

(72) Inventors: Wallace Trenholm, Etobicoke (CA); Maithili Mavinkurve, Markham (CA); Mark Alexiuk, Winnipeg (CA); Jason Haydaman, Winnipeg (CA)

(21) Appl. No.: 17/018,663

(22) Filed: Sep. 11, 2020

Related U.S. Application Data
(60) Provisional application No. 62/901,876, filed on Sep. 18, 2019.

(51) Int. Cl. G06F 21/60; G06F 21/62; G06F 16/182; G06N 20/00

(52) U.S. Cl. CPC G06F 21/602; G06F 21/604; G06N 20/00; G06F 16/1837; G06F 21/629; G06F 21/6227

(57) ABSTRACT

Systems and methods for sharing data assets via a computer-implemented data trust are provided herein. The method includes creating, in response to a user input, a data trust domain. Creating the domain includes instantiating a private network. The network includes a plurality of domain nodes. The domain nodes include a data producer node and a data consumer node. The data asset is provided by the data producer node. The method also includes defining access rights for the data asset as between the data consumer node and the data producer node. The method also includes creating a data pathway object. The data pathway object specifies the access rights for the data asset. The flow of data within the data trust domain is controlled according to the data pathway object.

### TECHNICAL FIELD

The following relates generally to data sharing, and more particularly to systems and methods for sharing a data asset via a computer-implemented data trust.

### INTRODUCTION

Current approaches to the sharing and exchange of data assets between entities, and the performance of data computations thereon, lack sufficient security infrastructure, immutability, and certifiability of data flow. Applications may not be secure, trustworthy, and transparent. There is a lack of transparency around data flows. Enterprise architects are forced to patch centralized systems with additional legal agreements and privacy preserving algorithms. According to traditional enterprise computing frameworks, access to data assets between data partners may be tackled via data sharing agreements, terms of service language, and legal paperwork. The intent of such documents is to ensure the sharing partners and their users can share the data in question between the partners and not face legal action. This methodology has minimal transparency and can raise privacy concerns, particularly when shared data contains identifiable information.

Data governance is becoming an increasingly important public policy issue. Data is becoming an increasingly valuable asset. Data stockpiles built with raw data, metadata, and derived data generated by smartphones, satellites, enterprise engines, IoT devices, as well as through traditional research and data collection methods are proliferating at a significant rate. Data companies are becoming increasingly valuable firms.

Various industries such as retail, financial services, travel, agriculture, security, defence, health and public services are increasingly relying on data-driven systems to drive business decisions and service delivery.

In the public domain, there is an increasing need to ensure data is used for the purposes for which it was intended (e.g. to benefit citizens). To capture the full value of data assets, trust in the data should be maintained in respect of how the data is collected, stored, shared and used.

Current approaches to data governance and sharing suffer from challenges. The creation of data sharing agreements is a slow and manual process that can create friction in business processes. Existing data sharing processes can be static, with data shared at specific times and with no real-time access. Data flow processes can be cumbersome across data producers and consumers, which can limit the breadth of data flow and statistical analysis. The costs of warehousing and cloud services are rising. Further, using current approaches, uncertainty often surrounds the allocation of rights including ownership of and transfer of access rights to data assets.

Centralized approaches to data governance and sharing rely heavily on a single actor. Such approaches require that the governing or holding party have significant trust from the data partners.

An open, transparent, and robust data trust and trading system is desired to reap the economic and social prosperity benefits from data, particularly data derived from artificial intelligence (“AI”) processes.

The status quo of centralized data harvesting enterprise computing systems is no longer sufficient. Consumers and businesses alike are demanding more trust and control from the systems and applications they use. Those contributing data need to be able to trust that their data is used appropriately. Further, external auditors need to be able to verify that the actions taken with that data comply with the relevant governance policies.

Accordingly, there is a need for an improved system and method for secure data sharing and exchange that overcomes at least some of the disadvantages of existing systems and methods.

### SUMMARY

A method of sharing a data asset via a computer-implemented data trust is provided herein. The method includes creating, in response to a user input, a data trust domain. Creating the data trust domain includes instantiating a private network. The private network includes a plurality of domain nodes. The domain nodes include a data producer node and a data consumer node. The data asset is provided by the data producer node. The method also includes defining access rights for the data asset as between the data consumer node and the data producer node. The method also includes creating a data pathway object. The data pathway object specifies the access rights for the data asset. The flow of data within the data trust domain is controlled according to the data pathway object.

The method may include providing the data consumer node with access to the data asset according to the data pathway object, wherein the access is provided via the private network.

The access rights may include a permitted computation. The permitted computation may include any one or more of a calculation, a model, or a computation that the data consumer node can perform on the data asset.

Providing the data consumer node with access may include running the permitted computation according to the data pathway object.

The method may include assigning each of the domain nodes a domain node account. The domain node account may be an account on a distributed ledger. The domain node account may be controlled by the domain node. The domain node can initiate a transaction on the distributed ledger from the domain node account.

The method may include assigning a synthetic account. The synthetic account may be an account on the distributed ledger. The synthetic account may represent a plurality of entities. The entities represented by the synthetic account can vote on policies of the synthetic account.

The method may include codifying, in a smart contract, the access rights specified in the data pathway object, wherein the smart contract, when executed, controls access to the data asset.

The method may include accessing the data asset via an artificial intelligence engine communicatively connected to the data producer node.

The data pathway object may define a network pathway along which data can travel.

The data asset may be a dataset or model generated during the machine learning lifecycle. The data assets may include a dataset, a derivative dataset, or a machine learning model.

The data pathway object may specify that the data asset is to pass through a computational node. The computational node may be configured to remove or obscure identifiable information.

The data pathway object may specify any one or more of ownership, routing, storage, processing, and access for the data asset.

The access rights may include a data handling policy. The data handling policy may be created based on metadata. The metadata may include any one or more of a data subject, a data source, a data format, a current and future identifiability of a data subject, a time of data acquisition, and a location of data acquisition.

The method may include codifying domain access rights in a smart contract. The smart contract, when executed, may control whether a domain node can access the data trust domain.

A system for providing a computer-implemented data trust for sharing a data asset is also provided. The system includes a data trust server. The data trust server includes a processor configured to create a data trust domain in response to a user input. The data trust domain includes a private network for communicatively connecting a plurality of domain nodes. The plurality of domain nodes include a data producer node and a data consumer node. The processor is also configured to create a data trust pathway object. The data trust pathway object specifies access rights for the data asset as between the data producer node and the data consumer node. The flow of data within the data trust domain is controlled according to the data trust pathway object.

The plurality of domain nodes may be added to the data trust domain according to a domain access policy. The domain access policy may be codified in a smart contract such that the smart contract, when executed, controls access to the data trust domain.

The processor may be further configured to assign a domain node account to each of the plurality of domain nodes. The domain node account may be an account on a distributed ledger. The domain node account may be controlled by the domain node. The domain node can initiate a transaction on the distributed ledger from the domain node account.

The data trust pathway object may define a network pathway along which data can travel.

The data pathway object may specify any one or more of ownership, routing, storage, processing, and access for the data asset.

The access rights specified in the data pathway object may be codified in a smart contract. The smart contract, when executed, may control access to the data asset.

Access to the data asset may be provided to the data consumer node according to the data trust pathway object, wherein the access is provided via the private network.

The access rights may include a permitted computation. The permitted computation may include any one or more of a calculation, a model, and a computation which the data consumer node can perform on the data asset.

Access to the data asset may include running a permitted computation according to the data pathway object. The permitted computation may include any one or more of a calculation, a model, and a computation which the data consumer node can perform on the data asset.

The processor may be further configured to generate a synthetic account comprising an account on the distributed ledger. The synthetic account may represent a plurality of entities each having a right to vote on policies of the synthetic account.

The system may include an artificial intelligence engine communicatively connected to the data producer node, wherein the data asset is accessible via the artificial intelligence engine.

The data asset may be generated during a machine learning lifecycle. The data asset may comprise any one or more of a dataset, a derivative dataset, or a machine learning model.

The data pathway object may specify that the data asset is to pass through a computational node configured to remove or obscure identifiable information.

The access rights may include a data handling policy created based on metadata. The metadata may include any one or more of a data subject, a data source, a data format, a current and future identifiability of a data subject, a time of data acquisition, and a location of data acquisition.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a system for a computer-implemented data trust, according to an embodiment;

FIG. 2 is a block diagram of a computing device of FIG. 1;

FIG. 3 is a block diagram of software components of the server of FIG. 1, according to an embodiment;

FIG. 4 is a block diagram of software components of a trust party device of FIG. 1, according to an embodiment;

FIG. 5 is a diagrammatic representation of a data trust, according to an embodiment;

FIG. 6A is a schematic diagram of a data trust system, according to an embodiment;

FIG. 6B is a block diagram of various components of the data trust system of FIG. 6A, according to an embodiment;

FIG. 7 is a block diagram of the AI engine of FIG. 6B, according to an embodiment;

FIG. 8 is a block diagram of various accounts of a data trust system, according to an embodiment;

FIG. 9 is a block diagram of a computer-implemented data trust system applied in a financial industry context, according to an embodiment; and

FIG. 10 is a flowchart of a method of operation of the system of FIG. 9, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to data control and access, and more particularly to systems and methods for a computer-implemented data trust for secure data sharing and exchange.

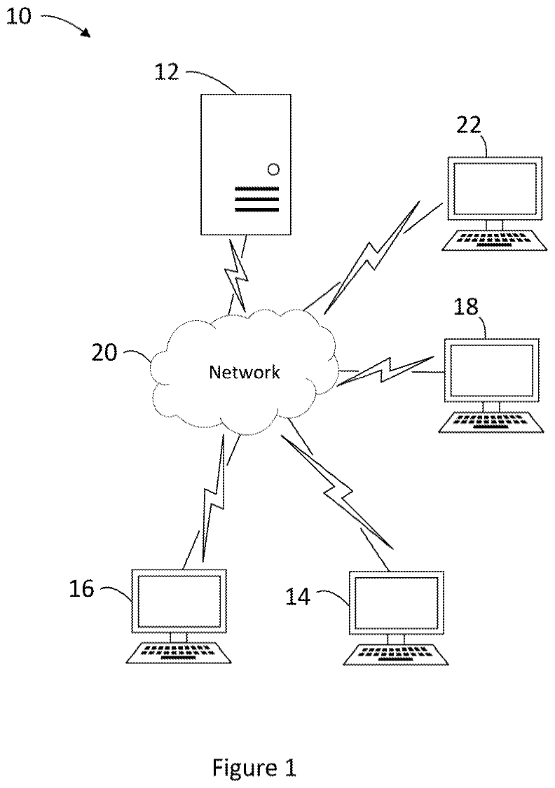

Referring now to FIG. 1, shown therein is a block diagram illustrating a system 10, in accordance with an embodiment. The system 10 includes a server platform 12 which communicates with a plurality of data provider devices 14, a plurality of data consumer devices 16, and a plurality of administrator (or trustee) devices 18 via a network 20. Devices 14, 16, 18 may be collectively referred to as “trust party devices” or “end user devices”. Devices 14, 16 may be collectively referred to as “data partner devices”. The devices 14, 16, 18 may also be referred to as “nodes” or “trust party nodes”. The server platform 12 may communicate with a plurality of distributed ledger computers 22 via the network. The server platform 12 may be a purpose-built machine designed specifically for providing a computer-implemented data trust for sharing and exchange of data assets between data partners (i.e. data providers and data consumers).

The server platform 12, data provider devices 14, data consumer devices 16, administrator devices 18 and distributed ledger computers 22 may be a server computer, desktop computer, notebook computer, tablet, PDA, smartphone, or another computing device. The devices 12, 14, 16, 18, 22 may include a connection with the network 20 such as a wired or wireless connection to the Internet. In some cases, the network 20 may include other types of computer or telecommunication networks. The network 20 may be a wide area network (WAN). The network 20 may be a private network, such as a virtual private network (VPN). The network 20 may be a software-defined WAN. The devices 12, 14, 16, 18, 22 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20. Input device may include any device for entering information into device 12, 14, 16, 18, 22. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18, 22 may include multiple of any one or more of processors, applications, software modules, second storage devices, network connections, input devices, output devices, and display devices.

Although devices 12, 14, 16, 18, 22 are described with various components, one skilled in the art will appreciate that the devices 12, 14, 16, 18, 22 may in some cases contain fewer, additional or different components. In addition, although aspects of an implementation of the devices 12, 14, 16, 18, 22 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18, 22 and/or processor to perform a particular method.

In the description that follows, devices such as server platform 12, data provider devices 14, data consumer devices 16, administrator devices 18, and distributed ledger computers 22 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 14, 16, 18, 22 may send information to the server platform 12. For example, a data provider using the data provider device 14 may manipulate one or more input devices (e.g. a mouse and a keyboard) to interact with a user interface displayed on a display of the data provider device 14. Generally, the device may receive a user interface from the network 20 (e.g. in the form of a webpage). Alternatively or in addition, a user interface may be stored locally at a device (e.g. a cache of a webpage or a mobile application).

Server platform 12 may be configured to receive a plurality of information, from each of the plurality of data provider devices 14, data consumer devices 16, administrator devices 18, and distributed ledger computers 22. Generally, the information may comprise at least an identifier identifying the data provider, data consumer, administrator, or distributed ledger computer. For example, the information may comprise one or more of a username, e-mail address, password, social media handle, or the like.

In response to receiving information, the server platform 12 may store the information in storage database. The storage may correspond with secondary storage of the device 12, 14, 16, 18, 22. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The data provider device 14 may be associated with a data provider account. Similarly, the data consumer device 16 may be associated with a data consumer account, the administrator device 18 may be associated with an administrator account, and the distributed ledger computer 22 may be associated with a distributed ledger computer account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

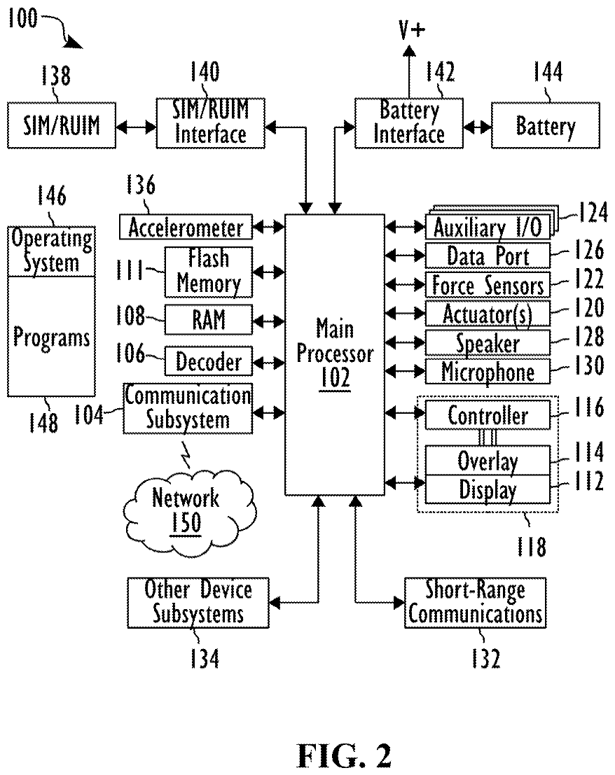

Referring now to FIG. 2, shown therein is a simplified block diagram of components of a computing device 100, according to an embodiment. The computing device 100 may be a mobile device or portable electronic device. The computing device 100 may be any of devices 12, 14, 16, 18, 22 of FIG. 1. The computing device 100 includes multiple components such as a processor 102 that controls the operations of the computing device 100. Communication functions, including data communications, voice communications, or both may be performed through a communication subsystem 104. Data received by the computing device 100 may be decompressed and decrypted by a decoder 106. The communication subsystem 104 may receive messages from and send messages to a wireless network 150.

The wireless network 150 may be any type of wireless network, including, but not limited to, data-centric wireless networks, voice-centric wireless networks, and dual-mode networks that support both voice and data communications.

The computing device 100 may be a battery-powered device and as shown includes a battery interface 142 for receiving one or more rechargeable batteries 144.

The processor 102 also interacts with additional subsystems such as a Random Access Memory (RAM) 108, a flash memory 110, a display 112 (e.g. with a touch-sensitive overlay 114 connected to an electronic controller 116 that together comprise a touch-sensitive display 118), an actuator assembly 120, one or more optional force sensors 122, an auxiliary input/output (I/O) subsystem 124, a data port 126, a speaker 128, a microphone 130, short-range communications systems 132 and other device subsystems 134.

In some embodiments, user-interaction with the graphical user interface may be performed through the touch-sensitive overlay 114. The processor 102 may interact with the touch-sensitive overlay 114 via the electronic controller 116. Information, such as text, characters, symbols, images, icons, and other items that may be displayed or rendered on a portable electronic device generated by the processor 102 may be displayed on the touch-sensitive display 118.

The processor 102 may also interact with an accelerometer 136 as shown in FIG. 2. The accelerometer 136 may be utilized for detecting direction of gravitational forces or gravity-induced reaction forces.

To identify a subscriber for network access according to the present embodiment, the computing device 100 may use a Subscriber Identity Module or a Removable User Identity Module (SIM/RUIM) card 138 inserted into a SIM/RUIM interface 140 for communication with a network (such as the wireless network 150). Alternatively, user identification information may be programmed into the flash memory 110 or performed using other techniques.

The computing device 100 also includes an operating system 146 and software components 148 that are executed by the processor 102 and which may be stored in a persistent data storage device such as the flash memory 110. Additional applications may be loaded onto the portable electronic device 100 through the wireless network 150, the auxiliary I/O subsystem 124, the data port 126, the short-range communications subsystem 132, or any other suitable device subsystem 134.

In use, a received signal such as a text message, an e-mail message, web page download, or other data may be processed by the communication subsystem 104 and input to the processor 102. The processor 102 then processes the received signal for output to the display 112 or alternatively to the auxiliary I/O subsystem 124. A subscriber may also compose data items, such as e-mail messages, for example, which may be transmitted over the wireless network 150 through the communication subsystem 104.

For voice communications, the overall operation of the portable electronic device 100 may be similar. The speaker 128 may output audible information converted from electrical signals, and the microphone 130 may convert audible information into electrical signals for processing.

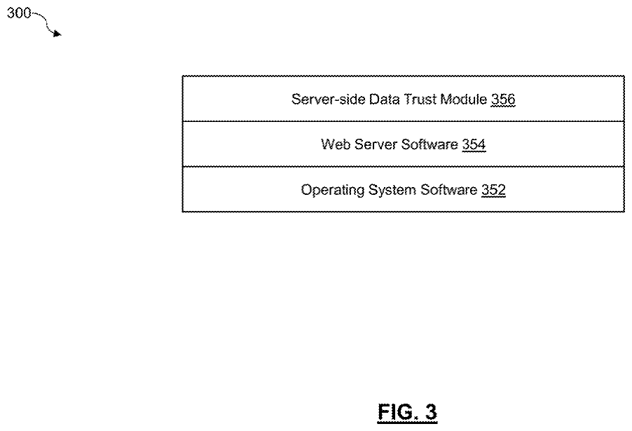

Referring now to FIG. 3, shown therein is a simplified organization of example software components 300 stored within memory of server 12. The software components 300 include operating system 352, web server software 354, and server-side data trust module 356. The software components 300 also include a data trust store (not shown). These software components 300, when executed, adapt the server 12 to operate according to embodiments described herein.

Operating system software 352 may be, for example, Microsoft Windows, Macinosh OSX, UNIX, or the like. OS software 352 allows web server software 354 to access one or more processors, network interface, persistent storage, memory, and one or more I/O interfaces of server 12.

OS software 352 includes a networking stack such as, for example, a TCP/IP stack, allowing server to communicate with end user computing devices through network interface using a protocol such as TCP/IP.

Web server software 354 may be, for example, Apache, Microsoft Internet Information Services (IIS), or the like.

Server-side data trust module 356 includes software components including instructions used in managing a data trust including controlling membership, access, storage of data assets and access thereto, and the like, that execute on one or more processors of server. Server-side data trust module 356 may, for example, store and retrieve what from secondary storage. Server-side data trust module 356, when executed, may cooperate with corresponding client-side components (i.e. executing on one or more processors of an end user computing device) to allow an end user device 14, 16, 18 to access the data trust and data assets held therein according to the rules and policies of the data trust and receive user input for same.

The data trust store stores data trust data and data assets. The data trust data and data assets may be stored in a structured format representative of a set of interrelated objects, such as a data trust domain and data trust pathways (described below).

In some embodiments, data trust store may be stored in persistent storage, in memory, or in both such as, for example, in the manner of a write-through or write-back cache. Data trust store may be an XML document, a relational database or an object-oriented database (such as, for example, Microsoft SQL Server, Oracle, DB2, Sybase, PostgreSQL), a NoSQL database (such as CouchDB, MongoDB, Hadoop or the like), or some combination thereof.

In some cases, the information in the data trust store may be stored in a further remote environment such as, for example, wherein the data trust store is located in a further remote environment accessible by way of, for example, a LAN or WAN such as may be accessed, for example, via network interface, or where data is replicated to additional storage in such a remote environment such as to provide enhanced availability or redundancy.

The server-side data trust module 356 adapts server 12, in combination with the data trust store and OS software 352 to operate as a device for implementing a data trust including managing and controlling access to data assets held therein.

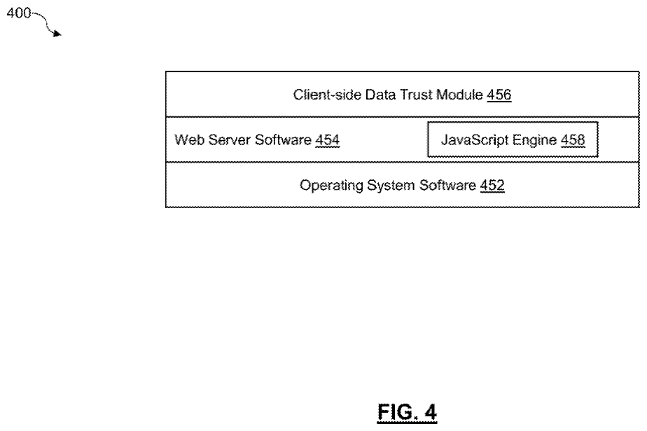

Referring now to FIG. 4, shown therein is a simplified organization of example software components 400 stored within memory of an end user computing device (e.g. device 14, 16, or 18 of FIG. 1). The software components 400 include operating system 452, web browser 454, and client-side data trust module 456.

OS software 452 may be, for example, Microsoft Windows, iOS, Android, or the like. OS software 452 allows web browser to access on or more processors, network interface, persistent storage, memory, and one or more I/O interfaces of end user computing device.

Web browser 454 may be, for example, Google Chrome, Chromium, Mozilla Firefox, Apple Safari, Microsoft Internet Explorer, Microsoft Edge, or the like. Web browser 454 enables end user computing device 14, 16, 18 to retrieve and render web pages such as may be accessed using network interface of end user computing device 14, 16, 18.

Web browser 454 may include JavaScript engine 458 which is responsible for executing JavaScript code such as may be retrieved by or included in one or more of the aforementioned web pages. For example, JavaScript engine 458 may execute JavaScript code in a web page and/or one or more JavaScript libraries referenced therein.

Client-side data trust module 456 includes software components including instructions used in managing and accessing a data trust and interacting with data assets held therein that execute on one or more processors of end user computing device. In some embodiments, client-side data trust module 456 may include JavaScript code that is executed by JavaScript engine. Client-side data trust module 456, when executed, may cooperate with server-side data trust module 356 executing on server 12 to allow end user device 14, 16, 18 to manage and access the data trust and the data assets held therein and receive user input for doing same.

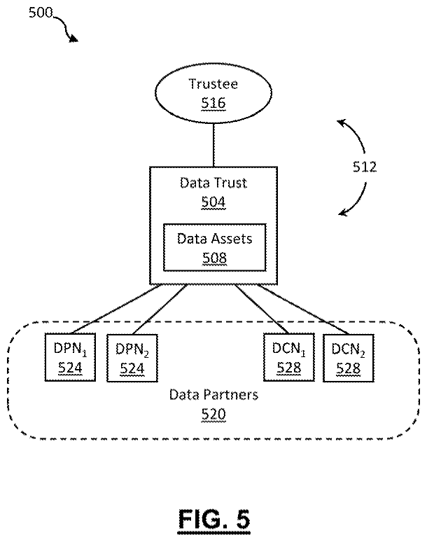

Referring now to FIG. 5, shown therein is a diagrammatic representation of a data trust system 500 for sharing and exchanging data assets, according to an embodiment.

The data trust system 500 implements a data trust 504 for a plurality of data assets 508. The data trust 504 is implemented for the benefit of a plurality of data partners 510. The data trust system 500 includes components and features that promote the secure sharing and exchange of the data assets 508 between the data partners 510. The data trust 504 includes policies and rules regarding the sharing and use of the data assets 508 by the data partners 510.

The data trust 504 includes a plurality of trust parties 512. Trust parties 512 may also be referred to herein as “members”. A trust party 512 may be an individual or an organization. The trust parties 512 include a trustee 516 and the data partners 510.

The trustee 516 administers and manages the data assets 508 in the data trust 504. The trustee 516 defines governance policies, rules, and regulations for the data trust 504, including the data assets 508.

The data partners 510 may be entities that want to access another party's data assets or monetize their own data assets. The data partners 510 include a plurality of data providers (DPN) 524 and a plurality of data consumers (DCN) 528. In some cases, a data partner 510 may be a data provider 524 and a data consumer 528.

The data provider 524 provides data assets 508 to the data trust 504. The data provider 524 can be considered a grantor of the data assets 508 within the data trust 504.

The data consumer 528 uses or accesses the data assets 508 for analysis or other purposes. Depending on permissions of the data trust 504 implemented by the data trust system 500, a data consumer 528 may only be permitted to access some of the data assets 508.

The data trust 504 includes governance rules (rules and policies) that determine rights in respect of the data assets 508 for data consumers 528 and data providers 524. The rights may include ownership rights, access rights, remuneration, and the like. The governance rules are enforced by the data trust system 500.

In some cases, a data partner 510 may be a party to multiple data trusts 504.

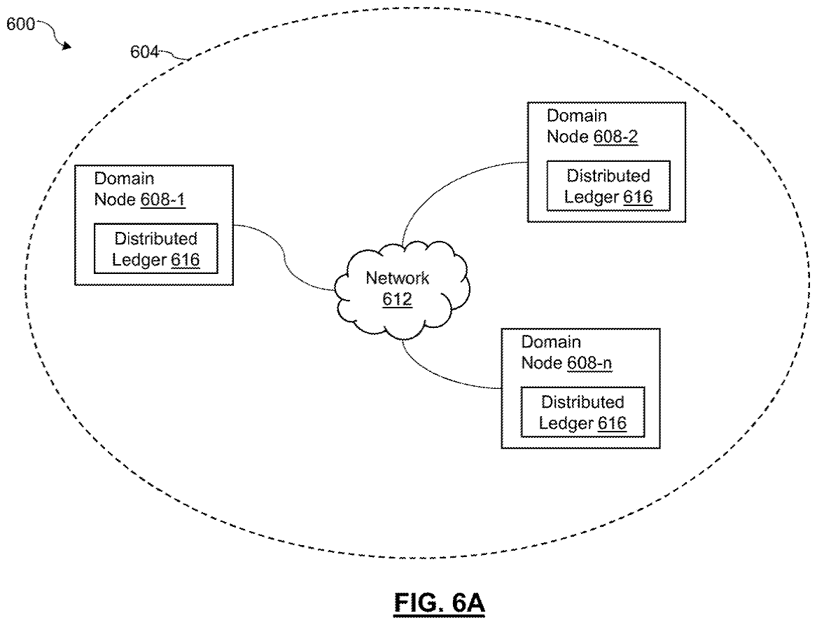

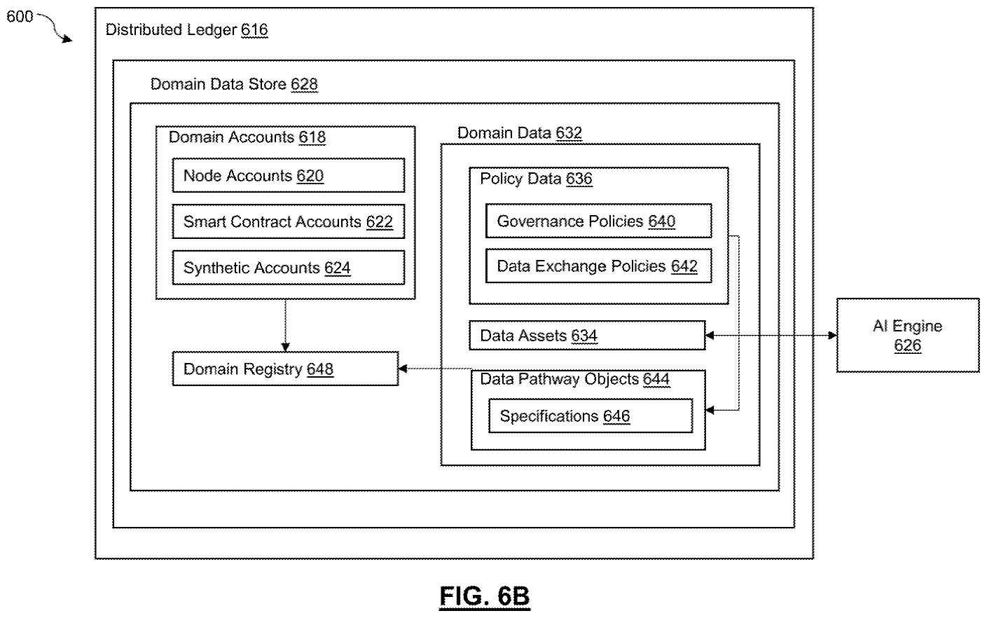

Referring now to FIGS. 6A and 6B, shown therein is a data trust system 600 according to an embodiment.

The data trust system 600 may provide security infrastructure, immutability, and certifiability of data flow. The data trust system 600 can be used by data partners 520 in data trust 504 to engage in data sharing and data computations while certifying trust. In an embodiment, the data trust system 600 can be implemented using the software components of FIGS. 3 and 4.

The data trust system 600 includes a data trust domain 604. The data trust domain 604 is a data exchange network. The data trust domain 604 may be created by the data trust system 600 on deployment. In an embodiment, the domain 604 is modelled as a data trust domain object.

The data trust domain 604 includes a plurality of data trust nodes 608-1, 608-2, and 608-n (or “nodes”). The data trust nodes 608-1, 608-2, and 608-n may be referred to collectively as nodes 608, and generically as node 608. Node 608 is a computing device (e.g. computing device 100 of FIG. 2) associated with a particular data trust party 512 (e.g. devices 14, 16, 18, 22 of FIG. 1). For example, nodes 608-1, 608-2, and 608-n may be associated with trustee 516, data producer 524, and data consumer 528, respectively.

The system 600 creates the domain 604 in response to a user input at node 608-1. In an embodiment, the system 600 provides a user interface at node 608-1, which may be end user device 18 of FIG. 1, for receiving the user input and sending the input data to server 12 of FIG. 1. The server 12 receives the domain creation indication/instructions and creates the domain 604. Node 608-1 is assigned the role of trustee 516 for the domain 604. The trustee assignment is changeable. For example, at creation of the domain 604, the creating node 608-1 may assign another node, such as node 608-2 or 608-n, as trustee of the domain 604. Similarly, the current trustee 516 can assign the role of trustee to another node 608 at some time after creation of the domain 604.

Nodes 608-2, 608-n can be added to the domain 604 by the trustee 516 (i.e. node 608-1). In an embodiment, a potential node can request to join the domain 604 via a user interface provided at the node device. Server 12 receives the join request from the requesting node and notifies the trustee node 608-1 via an alert, notification, or the like. Node 608-1 as the trustee 516 receives the join request. If the trustee 516 approves the request, the system 600 adds the requesting node to the domain 604. Nodes 608 are added to the domain 604 in accordance with policies and rules regarding membership and enrollment for the domain 604. Visibility of the domain 604 to potential nodes 608 may be controlled by the system 600 according to visibility policies and rules of the domain 604.

The nodes 608 in the domain 604 are connected via a private network 612. The network 612 may be a software-defined network (SDN), such as a software-defined wide area network (SD-WAN). The SD-WAN may be provided by a third-party service (e.g. Cisco) or an open source product (e.g. open v-switch, open contrail). The SD-WAN may be instantiated at the time the data trust domain 604 is created.

Advantageously, the SDN may simplify management and operation of the network 612 by decoupling the networking hardware from its control mechanism. A centralized controller is used to set policies and prioritize traffic. The SD-WAN considers these policies and the availability of network bandwidth to route traffic. The SD-WAN may improve application performance through a combination of WAN optimization techniques and its ability to dynamically shift traffic to links with bandwidth sufficient enough to accommodate each application's requirements. The SD-WAN may use automatic failover, so if one link fails or is congested, traffic is automatically redirected to another link. This may boost application performance and reduce latency. The SD-WAN architecture may enable administrators to reduce or eliminate reliance on expensive leased MPLS circuits by sending lower priority, less-sensitive data over cheaper public internet connections, reserving private links for mission-critical or latency-sensitive traffic, like VoIP. The SD-WAN may simplify the network 612 by automating site deployments, configurations and operations.

Node 608 includes a network interface (e.g. communications subsystem 104 of FIG. 2). In embodiments where the network 612 is an SDN, such as an SD-WAN, the network interface includes an SDN interface. The network interface may include a network address. The network address may be a unique associated numerical label or identifier. The network interface may provide network interface identification and location addressing for the node 608. In some cases, the node 608 may be a member of multiple data trust domains 604. In such a case, the node 608 may have multiple network interfaces or addresses, with one network address for each data trust domain 604 in which the node 608 is a member. Adding nodes 608 to the domain 604 may include the provision of a network address to the node 608 for the domain 604.

Access to the network 612, and thus to the domain 604, is controlled by the system 600 according to access rules and policies defined for the domain 604. Access rules and policies can be enacted in one or more smart contracts stored on a distributed ledger (e.g. distributed ledger 616, described below).

The private network 612 contains a distributed ledger network. The nodes 608 operate as nodes on the distributed ledger network. The distributed ledger network implements a distributed ledger 616 (or distributed ledger technology). Each domain node 608 stores a copy of the distributed ledger 616. The distributed ledger 616 is a consensus of replicated, shared, and synchronized digital data geographically spread across multiple nodes, which may be at multiple sites, countries, or institutions. The sequence of transactions, or events, in the distributed ledger 616 is locked by cryptographic means. The distributed ledger 616 may be a blockchain-type distributed ledger. The blockchain is a growing list of records, called blocks, which are linked using cryptography. Each block contains a cryptographic hash of the previous block a timestamp, and transaction data (generally represented as a Merkle tree). The distributed ledger 616 may be a private and permissioned blockchain. The private blockchain may be Hyperledger, R3 Corda, or Quorum.

The copy of the distributed ledger 616 stored by the node 608 is a replica of a shared append-only ledger of digitally signed transactions. The replicas are maintained in sync through a protocol referred to as consensus. The consensus protocol may use a consensus algorithm such as BFT, POW, POS, or the like. The system 600 controls who is allowed to participate in the network, execute the consensus protocol, and maintain the shared ledger 616.

The system 600 assigns each node 608 in the domain 604 a domain node account 620. The domain node account 620 is an account on the distributed ledger 616. The distributed ledger 616 includes domain accounts 618, which include domain node accounts 620 and domain smart contract accounts 622. The domain node account 620 may operate similarly to an external account on Ethereum. For example, the domain node account 620 is associated with an entity and is controlled by the entity (in contrast to a smart contract account). The entity is a trust party 512. The system 600 includes a user interface for allowing a user to interact with and through the domain node account 620, for example to make a domain join request, access a domain data asset, make a payment transaction, etc. The domain node account 620 may have rights and permissions associated it, which may be stored as attributes or properties of the account 620. For example, the domain node account 620 may have permission to create a smart contract 622 (i.e. a smart contract account on the distributed ledger 616). Smart contract 622 creation may be a permission exclusively provided to the domain node account 622 associated with the trustee 516 of the domain 604.

Domain accounts may include one or more synthetic accounts 624. The synthetic account 624 may be created by the system 600 at server 12 in response to a user instruction input at user interface of the trustee node 608-1. The synthetic account 624 may be an account that represents the interests of a subgroup of nodes 608 in the domain 604, or that represents a group external to the domain 604. The synthetic account 624 is functionally similar to domain node account 620 that represents the interests of a group of entities inside or outside the domain 604 that still adhere to the policies and consensus protocols of the domain 604. In an embodiment, the system 600 may generate synthetic accounts 624 for data subjects and data subject classes in the domain 604. Doing so may provide data subjects and subject classes an opportunity to own data in the domain 604 and any value derived from owned data. In a particular case where the data subject class is the general public, the system 600 may define shared ownership and shared value.

In some embodiments, the nodes 608 may be communicatively connected to an AI engine 626. A user may interact with the AI engine 626 via a point-and-click user interface at the end user device 14, 16, 18. The AI engine 626 may store, be linked to, or otherwise have access to various data assets (e.g. datasets, machine learning models) owned by the associated trust party 512 that can be managed, generated, or used by the AI engine 626. In this sense, trust parties 512 may provide or share data assets in the domain 604 through providing access to data assets stored by or otherwise accessible to the AI engine 626 (e.g. via a data store linked to AI engine 626). Data assets may be uploaded or imported to the domain 604, or access may be provided to data assets via a domain 604-AI engine 626 interface.

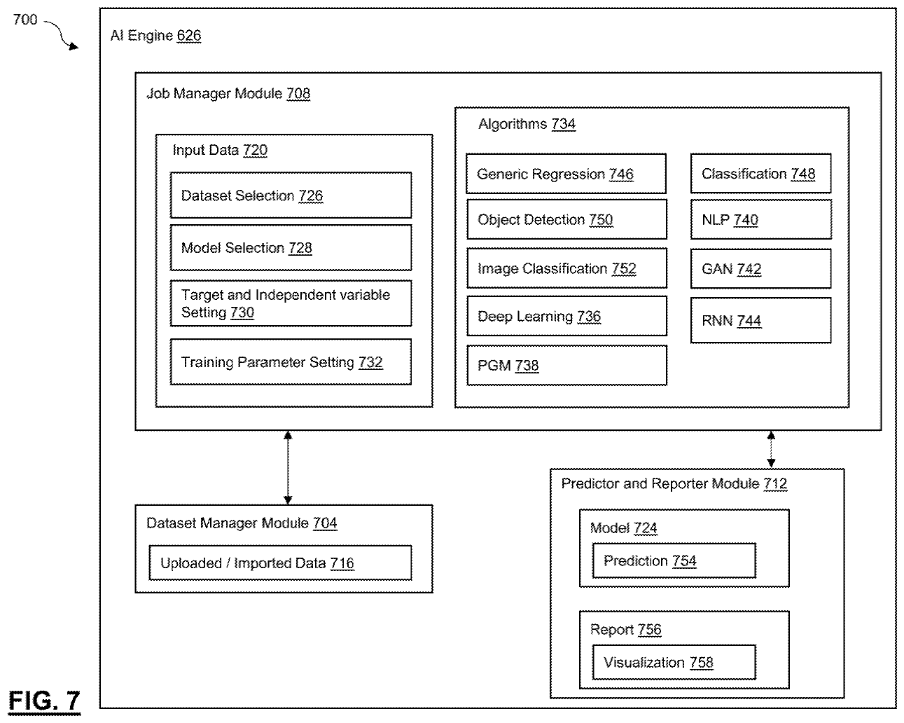

Referring now to FIG. 7, shown therein is a block diagram 700 of various components of AI engine 626 of FIG. 6B, according to an embodiment.

The AI engine 626 is configured to perform a process related to the AI or machine learning lifecycle. The AI engine 626 may communicate with the domain 604 via a data plane of the network 612. In this way, the AI engine 626 may provide access to data assets held in the domain 604.

The AI engine 626 includes a plurality of software modules. The software modules include a dataset manager module 704, a job manager module 708, and a predictor and reporter module 712.

The dataset manager module 704 is configured to manage uploading and importing of datasets 716. The dataset manager module 704 may be configured to generate one or more AI datasets. The dataset manager module 704 may receive structured or unstructured data and generate one or more datasets from the received data.

The job manager module 708 is configured to receive a variety of input data 720 from a user that can be used to train a machine learning model 724. The input data 720 includes a dataset selection 726, a machine learning model or algorithm selection 728 (e.g. SSD), a target and independent variable setting 730, and a training parameter setting 732.

The job manager module 708 is configured to train and generate a machine learning model using the received input data 720 and deploy the model 724.

To train and generate the model 724, the job manager module 708 includes a plurality of machine learning algorithms 734. Algorithms 734 may include, for example, deep learning algorithms 736, probabilistic graph models ensembles 738, natural language processing 740, generative adversarial networks (GANs) 742, and the like. The algorithms 734 may include recurrent neural networks 744. The RNNs may include many to many and many to one RNNs. The algorithms 734 include generic regression 746. The generic regression algorithms 746 may include random forest, linear regression, MLP, partial least squares, Field-aware factorization machine, and the like. The algorithms 734 may include classification algorithms 748. The classification algorithms 748 may include random forest, support vector machines, MLP, field-aware factorization machine, and the like. The algorithms 734 may include object detection 750, such as SSD. The algorithms 734 may include image classification 752 such as VGG, ResNet, semantic segmentation, and the like. The algorithms 734 may include OCR. The OCR may be attention OCR. The algorithms 734 may include sequence to sequence such as Seq2Seq.

The predictor and reporter module 712 is configured to validate model 724 performance on test data, evaluate model 724 performance (expected vs. predicted), generate predictions 754 on line data in a production environment, and report results 756. Reporting results includes generating a visualization 758 (e.g. maps/charts, heat maps, or the like) reporting performance.

The AI engine 626 may access data stored in a data store such as a presto database server. The AI engine 626 may access the data via an AI engine-data store interface (e.g. AI engine-prestodb interface).

Referring again to FIG. 6, the domain 604 includes a domain data store 628. The data store 628, or a portion thereof, may be stored on the distributed ledger 616. Data store 628, or a portion thereof, may be located at, linked to, or otherwise accessible to data trust server 12. The data store 628 stores domain data 632. Domain data 632 includes data about the domain 604 itself, domain data assets 634, policy data 636, etc. Policy data 636 includes policies for accessing and managing the domain 604 and data assets 634 held therein that can be enacted and enforced via smart contracts 622.

Data about the domain itself may include membership and enrollment information (e.g. trust party IDs, trustee ID,) domain accounts, data assets and asset metadata (e.g. ownership of shared data assets), etc.

Data assets 634 are the data being shared in the domain 604. Data assets 634 managed (i.e. shared, exchanged, etc.) using the system 600 may be referred to throughout the present disclosure as “data assets” or “data”. The data assets 634 may include any data or model created, produced, generated, used, or modified throughout the machine learning or AI lifecycle. The machine learning lifecycle may include planning, data engineering, and modelling phases. Data engineering may include data analysis, data extraction, data transformation, data management, and data serving. Modelling may include feature engineering, model generation, model serving, and continuous learning. Data assets 634 may include datasets, derivative datasets, analytics, and machine learning models. Datasets may be used to train machine learning models. Data assets 634 may be created by the AI engine 626. The data assets 634 controlled by the system 600 may be in existence at the time the domain 604 is created, or may be generated after domain 604 creation, such as by one or more nodes 608 in the domain 604 via the AI engine 626.

The domain data 632 includes policy data 636. Policy data 636 includes governing policies and rules 640 for the domain 604. The governing policies and rules 640 may be agreed upon by the trust parties 512 and managed by the trustee 516 of the domain 604. The policies 640 may include domain visibility policies, domain enrollment and membership policies, remuneration of trust parties (e.g. data producers) policies, and domain account identity policies.

Policy data 636 also includes data exchange policies 642. The data exchange policies 642 define how domain data assets 634 can be exchanged, shared, or accessed via the domain 604 and what computations can be performed on the domain data assets 634. Data exchange policies 642 include policies for handling each datum shared in the domain 604.

Certain policy data 636 for the domain 604, for example policy data 636 related to data asset access (exchange and use), can be modelled in one or more data pathway objects 644. The data pathway object 644 defines a network pathway along which data can travel. The pathway object 644 may include computer-executable instructions for providing access to a data asset 634 according to the data pathway.

The data pathway object 644 includes specifications 646. The specifications 646 may specify any one or more of a data asset 634 to which the pathway object 644 applies, a data asset provider or source node ID, a data consumer or access-receiving node ID, permitted computations that can be performed on the data asset (e.g. using the AI engine 626), required actions (e.g. computations to remove identifiable information in the data) prior to receiving access or using the data asset 634, and any other rules (or information desired or needed) regarding access or use of the shared domain data asset 634. The data may include network addresses for the nodes 608, wherein the network addresses are on the private network 612 of the domain 604. Specifications 646 of the data pathway object 644 may also define ownership, routing, storage, processing, and access of each datum (data asset) shared in the domain 604. The information specified in the data pathway object 644 may be stored as attributes or properties of the data pathway object 644. Data pathway objects 644 may be stored on the distributed ledger 616.

Domain data 632, including policy data 636 and pathway objects 644, may be registered or recorded in one or more registries, such as a domain registry 648. The registries may be stored on the distributed ledger 616.

Policy data 636 may include datum handling policies created based on metadata. The metadata may include any one or more of a data subject (e.g. environment, asset, person, animal, vehicle, etc.), a data source (e.g. sensor, camera, database, mobile app, biological assay, satellite, etc.), a data format (e.g. image, time series, structured text record, etc.), a current and future identifiability of the data subject, a time of data acquisition, and a location of data acquisition. The metadata is stored in data store 624.

Policy data 636 may include policies for derivative data. Derivative data includes data produced by joining, transforming, or making predictions on existing data within the data trust/domain 604.

Policy data 636 may include governance policies for the data pathway objects 644. These policies may be captured in a data pathway object registry.

The data pathway objects 644 are implemented to create one or more smart contracts 622 on the distributed ledger 616. Nodes 608 can access data assets 634 (e.g. run permitted computations on the data assets) according to data pathway object specifications 646 via smart contract 622 execution.

The smart contract 622 includes computer-executable instructions or code that, when executed, controls and manages access to the domain 604 and the data assets 634 shared therein. The smart contract 622 provides declarative programming logic for operations on the distributed ledger 616. The smart contract 622 may codify certain policy data 636 such that, when the smart contract 622 is enacted, messaged (or otherwise transacted with), and executed, access to the data assets 634 and the domain 604 is controlled in accordance with the policies of the domain 604 reflected by the policy data 636. The smart contract 622 may be registered in the domain registry 648.

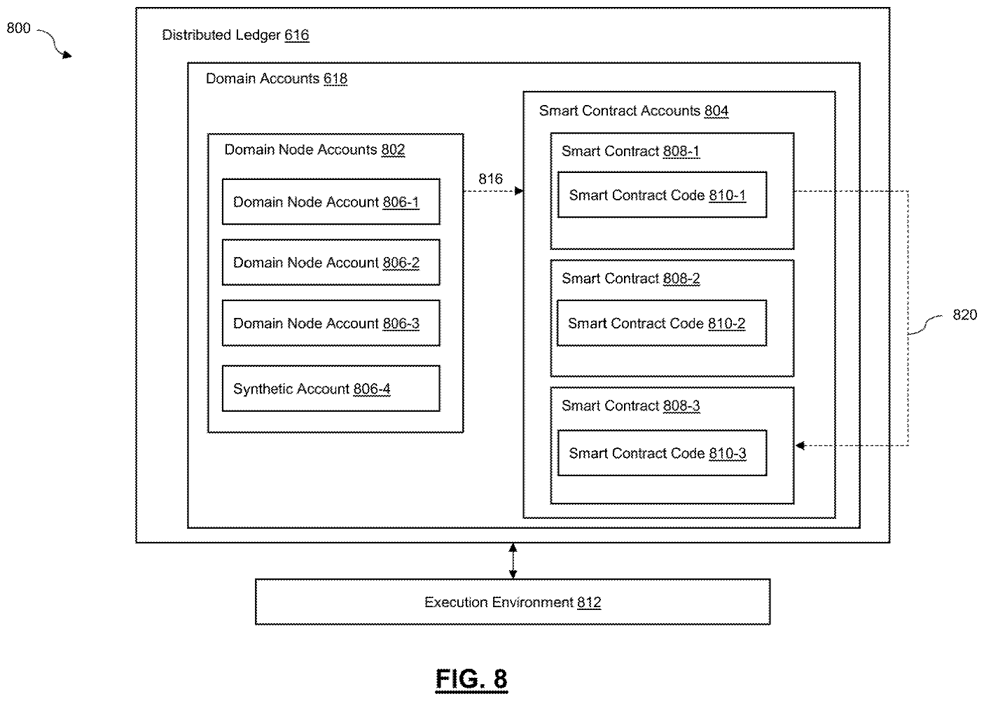

Referring now to FIG. 8, shown therein is a block diagram representation 800 of domain accounts 618 on the distributed ledger 616 of system 600, according to an embodiment.

The domain accounts 618 include domain node accounts 802 and domain smart contract accounts 804. The accounts 802, 804 are communicatively connected to an execution environment 812. The execution environment 812 may be the Ethereum Virtual Machine or similar execution environment.

The domain node accounts 802 include accounts for each node in the domain 604, namely, node 608-1 account 806-1, node 608-2 account 806-2, and node 608-n account 806-3. The domain accounts 618 also include a synthetic account 806-4. The synthetic account 806-4 represents a plurality of entities that may be internal or external to the domain 604.

The smart contract accounts 804 include a first smart contract account 808-1, a second smart contract account 808-2, and a third smart contract account 808-3. Smart contract accounts 808-1, 808-2, 808-3 include smart contract code 810-1, 810-2, and 810-3, respectively. The smart contract code 810 may, when executed, implement or enforce policies of the domain 604 related to the access, control, and management of the domain 604 and assets 634 shared in the domain 604. For example, smart contract code 810-1 may relate to domain access and management, smart contract code 810-2 may relate to access rights to a first data asset, and smart contract code 810-3 may relate to access rights to a second data asset including permitted computations. While FIG. 8 shows three smart contract accounts, this is merely exemplary and not limiting, and it is understood that fewer or more smart contract accounts may be used with varying content. Further, the content of the smart contracts 804 may vary. Generally, however, it is understood that the content of the smart contracts 804 includes, reflects, or enforces the policies of the domain 604 regarding access, control, management, and the like.

In an embodiment, any one of smart contracts 622 may codify voting rights for particular domain node accounts 802. The voting rights may allow the owner (or other permitted user) of the domain node account 802 to vote on policies of the account, which may effectively provide affected parties input in how their data is used. This may be particularly advantageous in the case of a synthetic domain account, such as synthetic account 806-4, where individuals represented by the synthetic domain account 806-4 are permitted to vote on the policies of the account.

The smart contract code 810 may codify certain information specified in the pathway objects 644. The smart contract code 810 may define any one or more of ownership, routing, storage, processing, and access of each datum shared in the domain 604.

The smart contract code 810 may govern what nodes 608 can be added to or otherwise access the domain 604. This effectively governs who can join the data trust.

The smart contract code 810 may govern how the domain data assets 634 are shared, exchanged, and accessed in the domain 604, and what computations can be performed on the data assets 634.

Each smart contract account 804 includes the associated code 810 (computer-executable instructions).

The smart contract account 808 is controlled by the associated code 810. Execution of the smart contract code 810 may be triggered by transactions or messages (calls) received from other smart contracts 804 (i.e. from other smart contract accounts 804). The smart contract code 810, when executed, may perform operations of arbitrary complexity (Turing completeness), manipulate its own persistent storage (i.e. can have its own permanent state), or call/message other smart contracts 804. The smart contract account 804 has an address. The smart contract address is determined at the time the contract is created. The address may be derived from the creator address and the number of transactions sent from that address, the so-called “nonce”.

The two types of domain accounts 618 are treated equally by the execution environment 812. Each domain account 618 may have a persistent key-value store mapping 256-bit words to 256-bit words called storage. Each domain account 618 may have a balance in some value token (e.g. Ether or “Wei” in an Ethereum-based embodiment) which can be modified by sending transactions that include the token.

Each domain account 618 may have a persistent memory area called storage. Storage may be a key-value store that maps 256-bit words to 256-bit words. It is not possible to enumerate storage from within a contract and it is comparatively costly to read and even more so, to modify storage. A contract can neither read nor write to any storage apart from its own. The domain account 618 has a second memory area called memory, of which a contract obtains a freshly cleared instance for each message call.

Action on the distributed ledger 616 may be initiated by a transaction 816 initiated or sent from a domain node account 802. A transaction 816 may be sent from a domain node account 802 to a smart contract account 804. When the smart contract account 804 receives the transaction 816, the smart contract code 810 of the smart contract account 804 is executed. The code 810 is executed as instructed by the input parameters sent as part of the transaction 816. The smart contract code 810 is executed in the execution environment 812 on each domain node 608 participating in the network as part of the verification of transactions or new blocks.

If the target account contains code 810, the code 810 is executed and the payload is provided as input data.

A transaction may have a target account that is a designated account (e.g. a zero-account, the account with address 0) for creating a new contract 804. The transaction creates a new contract. The address of the contract 804 is not the zero address but an address derived from the sender and its number of transactions sent (the “nonce”). The payload of the contract creation transaction may be taken to be execution environment bytecode and executed. The output of the execution can be permanently stored as the code 810 of the contract 808.

The transaction 816 may contain a message recipient and a signature identifying the message sender and proving their intention to send the message via the distributed ledger 616 to the recipient. The transaction 816 may also contain an optional data field which may contain the message sent to a contract 808. The transaction 816 may also include data related to the maximum number of computational steps the transaction execution is allowed to take and a transfer of value. In an embodiment using Ethereum, the transaction may also contain an amount of wei to transfer from the sender to the recipient, a startgas value, and a gasprice value.

A smart contract 808 can send a message 820 to another smart contract 808 (e.g. smart contract 808-1 to 808-2). The message 820 may be a virtual object that is not serialized and exists only in the execution environment 812. The message 820 may be similar to a function call. The message 820 may be an object including a byte-array of data of any size, a sender address, a recipient address, and a value quantity (e.g. a quantity of ether in an embodiment using Ethereum).

The message 820 contains a message sender (implicit) and a message recipient. The message 820 may include an optional data field that is the actual input data to the contract. The message 820 may also include a value transfer amount with the message to the contract address. In an embodiment using Ethereum, the message 820 may also contain a value field including an amount of wei to transfer alongside the message to the contract address and a startgas value limiting the maximum amount of gas the code execution triggered by the message can incur. The message 820 may be generated when a contract currently executing code executes a call (e.g. via a CALL or DELEGATECALL opcode), thereby producing and executing a message. Similar to a transaction, the message 820 leads to the recipient account running its code.

Messages 820 and transactions 816 may be similar, except that a message is produced by a smart contract 808 and not an external actor.

Smart contract 808-1 can call other contracts 808-2, 808-3 or send tokens (e.g. Ether) to domain node accounts 806 via message calls. Message calls include a source, a target, data payload, and return data. In an embodiment using Ethereum, the message call includes Ether and gas. Each transaction may include a top-level message call which can create further message calls. The called smart contract 808 (which may be the same as the caller) receives a freshly cleared instance of memory and has access to the call payload (which may be provided in a separate area called the call data). After the contract has finished execution, the contract can return data which may be stored at a location in the caller's memory pre-allocated by the caller.

Each domain node 608 participating in the network runs the execution environment 812 as part of a verification protocol (e.g. block verification protocol). A node goes through transactions listed in the block it is verifying and runs the code as triggered by the transaction within the execution environment 812. Each full node in the blockchain network does the same calculations and stores the same values. Contract executions are redundantly executed across nodes 608.

Generally, in a default state nothing happens in the execution environment 812 and the state of every domain account 618 remains the same. A user can trigger an action by sending a transaction 816 from a domain node account 802. The transaction destination may be a domain node account 802 or a smart contract account 804. If the transaction destination is a domain node account 802, the transaction 816 may transfer some value (e.g. ether). If the transaction destination is a smart contract account 804, the smart contract 808 activates and automatically runs the smart contract code 810.

The smart contract code 810 may read/write to its own internal storage (e.g. a database mapping 32-byte keys to 32-byte values). The smart contract code 810 may read the storage of a received message and send a message to another smart contract account 804, triggering execution of the receiving smart contract account 804.

The smart contract 808 is triggered by a transaction 816 or a message 820. When the smart contract 808 is triggered, every instruction is executed on every node 608 of the blockchain network.

Smart contract account 808-1 can interact with a smart contract account 808-2 via “calling” or “sending messages”. The smart contract 808-2 receives a message 820 sent by smart contract 808-1. Smart contract 808-2 can return some data, which smart contract 808-1 (i.e. the original sender of the message) can immediately use. Sending a message is similar to calling a function.

Smart contract 808-1 may be configured to provide functions to another smart contract 808-2. In such a case, the smart contract 808-1 may act similarly to a software library.

The smart contract 622 may define specific processing and/or privacy requirements for each user of the data asset. This may allow multiple parties to exploit the same source data. Advantageously, the system 600 also keeps the collectively owned data in place and sensitive information (e.g. identifiable information) is not repeatedly copied and shared throughout the domain 604.

The domain node accounts 802 can send transactions 816, which may include a transfer (e.g. of value, such as a token) or trigger a smart contract call. A transaction 816 may be considered to refer to a signed data package that stores a message to be sent from a domain node account 802 to another account 802, 804 on the ledger 616. A transaction 816 is a message that is sent from one account to another account (which might be the same or the special zero-account, see below). The transaction 816 can include binary data (its payload) and Ether.

The domain node account 802 may be an account controlled by a private key. Using the private key, transactions and messages can be sent from the domain node account 802. The domain node account 802 may be controlled by a public-private key pair. The address of the domain node account 802 may be determined from the public key.

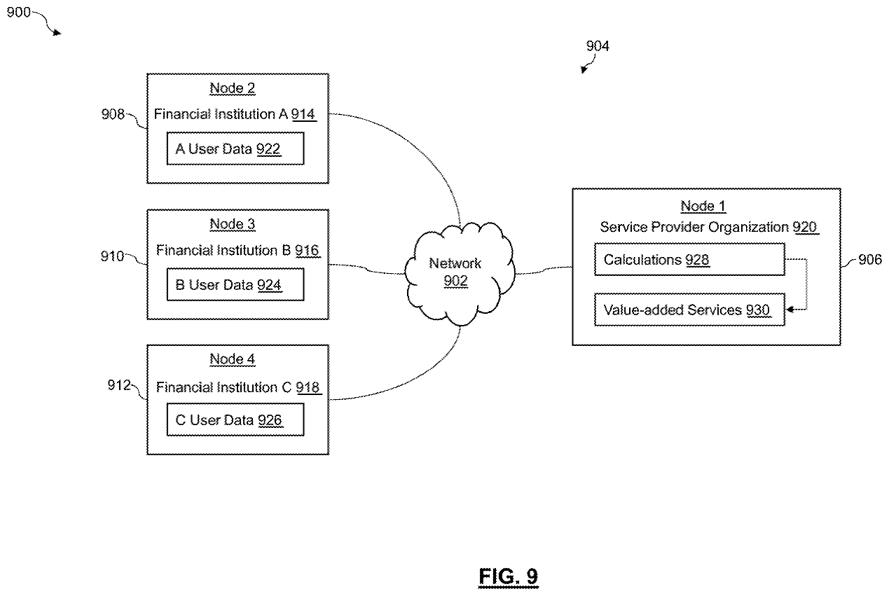

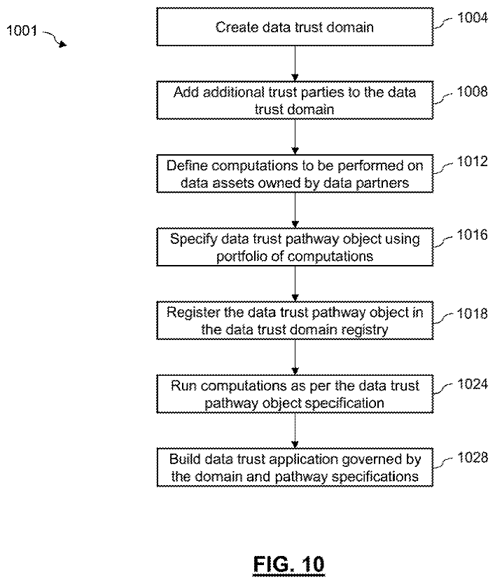

FIGS. 9 and 10 illustrate an example data trust, according to an embodiment. The example illustrates how a computer-implemented data trust according to the present disclosure may be implemented in a financial industry context.

Referring now to FIG. 9, shown therein is a block diagram of computer-implemented data trust 900, according to an embodiment. The data trust 900 may be implemented by system 10 of FIG. 1 and, in particular, by data trust server 12 of FIG. 1.

The data trust 900 includes a data trust domain 904. The domain 904 includes a plurality of nodes 906, 908, 910, and 912. The domain 904 includes a private software-defined network 902 connecting nodes 906, 908, 910, and 912. The domain 904 holds a plurality of data assets 922, 924, 926 (described below). Each of the nodes 906-912 is communicatively connected to an AI engine (e.g. AI engine 626 of FIG. 6) configured to provide dataset management, training and generation of machine learning models, and prediction and reporting on generated models.

The data trust 900 includes trust parties 914, 916, 918, 920. Each node in the network 902 is associated with a trust party. Trust party 914 is associated with node 908, trust party 916 is associated with node 910, trust party 918 is associated with node 912, and trust party 920 is associated with node 906.

Trust Parties 914, 916, 918 are financial institutions that hold data assets 922, 924, 926, respectively. Data assets 922, 924, 926 include data about users of the respective financial institutions. For example, data asset 922 includes data about users of financial institution 914.

Trust party 920 is a service-provider organization. Trust party 920 can perform specific calculations 928 on data and return value-added services 930. Trust party 920 wants access to data assets 922, 924, 926 for the purposes of performing calculations 928 on the data assets and generating the value-added services 930.

Under traditional enterprise computing approaches, trust party 920 access to data assets 922, 924, 926 is typically provided via data sharing agreements, terms of services language and legal paperwork designed to ensure trust parties 914, 916, 918, 920 and their users can share data assets 922, 924, 926 between parties and not face legal action. Such an approach has minimal transparency and can raise many privacy concerns.

Data trust 900 allows trust parties 914, 916, 918, 920 to engage in data sharing and data computations while certifying trust.

Referring now to FIG. 10, shown therein is a method 1001 of operation of the data trust 900 of FIG. 9, according to an embodiment.

At 1004, data trust domain 904 is created. The domain 904 is created by trust party 920. In variations, any of trust parties 914, 916, 918 may create the domain 904.

Trust party 920 is designated as trustee of the data trust 900. Designation of trust party 920 as trustee may occur automatically upon creating the domain 904, or trust party 920 may designate itself. Server 12 implementing the data trust 900 may generate the domain 904 in response to receiving input data from an end user device (e.g. trustee device 18 of FIG. 1) associated with trust party 920 (i.e. node 906). The input data may be provided by trust party 920 via a user interface at the end user device.

At 1008, trust parties 914, 916, 918 are added to the data trust domain 904. Added parties may be designated as having one or more roles in the trust, such as a data provider, a data consumer, or both a data producer and consumer. Such trust role data can be stored by the data trust 900 (e.g. by server 12). The trust role data can be stored in a data store, such as data store 628 of FIG. 6. The data store may be stored on a distributed ledger, such as distributed ledger 616 of FIG. 6. In the present example, trust parties 914, 916, 918 are designated data producers. Trust party 920, in addition to its role as trustee, may also be a data consumer.

Upon adding the trust parties 914, 916, 918 to the domain 904, the server 12 generates a domain node account (e.g. node accounts 620 of FIG. 6) for each trust party. The domain node accounts are stored on the distributed ledger.

Trust parties 914, 916, 918 are identified as holding data assets 922, 924, and 926, which are subject to the trust 900. Such data asset ownership data can be stored by the data trust 900 (e.g. by server 12) in the data trust data store.

At 1012, trust party 920 as trustee defines one or more computations to be performed on data assets 922, 924, 926. The computations may be considered permitted computations. The permitted computations are computations that a given trust party can perform on a data asset shared in the trust 900. Permitted computations may differ across data assets 922, 924, 926 and trust parties 914, 916, 918. The computations may include calculations, models, computations, or the like. The computations may be performed by the AI engine. The collection of computations are placed in a portfolio of computations.

At 1016, the portfolio of computations is placed into specifications of data trust pathway objects, such as specification 646 of pathway objects 644 of FIG. 6. The data pathway specifications may be used to create one or more smart contracts to govern the flow of data (e.g. data from data assets 922, 924, 926) within the data trust domain 904.

At 1018, the data trust pathway objects are registered in a data trust domain registry (e.g. registry 648 of FIG. 6).

At 1024, trust parties 914, 916, 918 can run the computations as per the data trust pathway object specification.

At 1028, trust parties 914, 916, 918, 920 can build enterprise data trust applications governed by the data trust domain 904 and data trust pathway specifications. The data trust applications are configured such that the flow of data, the policies, and governance of the data is executed according to the data trust pathway specification.

Various example applications of the data trust systems and methods described herein will now be discussed. Such example applications are intended to be merely illustrative of potential applications and are not limiting.

In an example, the data trust system 600 of FIG. 6 can be used to share and exploit security camera or surveillance video data via a video data trust. The video data may be acquired, for example, via transit cameras or the like.

The video data trust may include data trust pathway objects having a data subject and a data subject class. The data subjects in security camera video data are the individuals being monitored.

Collection of the video data, while potentially legal, poses a privacy concern to the data subjects. Even if the video data is used for a benign or desirable purpose, the video data still contains identifiable information (e.g. faces) that a subject class (people being videoed) may not be comfortable sharing. Multiple entities within the city may find the video data useful by merging it with their own datasets for other purposes. However, making copies of the video data increases the visibility of the identifiable information and the risk of privacy and security violations should the video data fall into the wrong hands. The data trust can be used to define explicit policies surrounding the use of the video data. The data trust can also provide the data subjects an opportunity to verify that their video data is used appropriately.

A smart contract in the data trust pathway object can be defined to force the video data to pass through a computational node. The computational node is configured to strip or otherwise obscure identifiable information from each datum before sending the de-identified data to a machine learning application. This approach advantageously shares only the data that needs to be shared. Auditors can verify, on the public's behalf, that the agreed-upon de-identification is performed.

Multiple organizations may exploit the same source data by working with derivatives that pass through a series of operations defined in separate smart contracts. Thus, even when sensitive data is collected out of necessity, the sensitive aspects of the data are not widely shared and its movement or transformation is governed by verifiable means.

Data subjects and data subject classes may be given synthetic accounts (e.g. synthetic accounts 624 of FIG. 6) in the data trust domain. The synthetic accounts may provide the data subjects and data subject classes the opportunity to own data in the data trust and any value derived from owned data. If the subject class is the general public, shared ownership and shared value can be explicitly defined. Smart contract policies can be enacted so that individuals represented by the synthetic account can vote on the policies of the account, which may give affected individuals a say in how their data is used.

The present example may be used by transit services leveraging video surveillance. Public transit authorities across North America are modernizing their processes to more efficiently streamline access by passengers. This may include implementing trust protocols or digitized tickets to minimize the overhead at entrances or exits that often lead to a bottleneck or delays. While such processes yield more efficient commuting, they may also result in potential blind spots that increase the likelihood for fare evasion and transit fraud. As such, modern transit processes can be counterbalanced with innovative tools to combat daily fraud.

Addressing such instances of fraud may entail locally integrating AI with security cameras and automated entrances to autonomously identify whether a passenger has complied or evaded fare inspection. Such analysis can be distributed to transit authorities and operators in real-time via a mobile app so personnel can actively investigate and/or prioritize their resources at designated areas determined to be high risk.

Using the data trust system 600, the video data collected throughout each passenger's commute may be protected as part of a data trust Application (dtApp) design. Upon capturing an incident of transit fraud, the dtApp administers only the minimum necessary video data (i.e. video footage) to the data consumers (i.e. the trust's beneficiaries), such as transit officers or regional authorities, to verify and investigate the incident in the field. The system 600 may also provide auditable records for regulators, governments and human rights agencies to review and verify the preservation of privacy rights.

In another example, the data trust system 600 may be used to implement a smart city data trust. A smart city is an urban area that uses different types of electronic Internet of things (IoT) sensors to collect data and then use these data to manage assets and resources efficiently. This may include data collected from citizens, devices, and assets that is processed and analyzed to monitor and manage traffic and transportation systems, power plants, water supply networks, waste management, crime detection, information systems, schools, libraries, hospitals, and other community services.

The data trust system 600 may be used by a city to define data subjects and data subject classes that are affected by the data collection. These entities can be exposed to the data trust domain as synthetic accounts. The synthetic accounts may provide data subjects and subject classes an opportunity to own data in the data trust and any value derived from owned data.

A synthetic account for a data subject class is an entity that can represent a specific group of individuals or all members of the public (e.g. all the residents of the city). The construct allows the trustee to explicitly define governing policies for shared data ownership and sharing the value created by collectively owned data.

To enable active participation of the data subjects, smart contract policies can be enacted on the synthetic account so that individuals represented by the account can vote on the smart contract policies using a data trust application. This governance structure provides affected individuals or parties a say in how the collectively owned data is used.

Data subjects and subject classes may be given synthetic accounts in the data trust domain. The synthetic accounts provide an opportunity for subjects and subject classes to own data in the domain/trust and any value derived from owned data. In a particular case, the subject class may be the general public. Shared ownership and shared value can be explicitly defined. The system 600 can enact smart contract policies allowing individuals represented by the synthetic account to vote on policies of the account. Such voting rights can provide affected individuals with input on how their data is used.

In another example, the data trust system 600 may be used for performance tracking for financial assets.

Current approaches to performance tracking of assets and investments by entities like public private partnerships can be outdated and ambiguous.

The data trust system 600 may include smart contracts via blockchain, key performance indicators (“KPIs”) measured by leveraging artificial intelligence, and digital rights and remuneration for data producers.

The data trust system 600 includes one or more smart contracts. The smart contract code may allow decentralized automation by enforcing, verifying, and facilitating conditions of an underlying contract. Agreed-upon KPIs and voting policies for matters can be captured in the smart contract.

Traditional measures of KPIs can be vague and inadequate. This can be especially true for elements that are currently difficult to quantify. As an example, a public-private partnership (“PPP”) established to build a new gas pipeline may be tied to multiple environment metrics.

The data trust system 600 may receive satellite image data (e.g. data assets 634) and apply specialized algorithms (computations) to the satellite image data. The application of the algorithms to the image data may be used to monitor changes in land contours, soil composition, drainage patterns, and the like. By monitoring changes, trust parties (partners) can be held accountable to agreed-upon metrics captured in the smart contract.

In an embodiment, government payments into a special purpose vehicle (“SPV”) may be tied to achievement of KPIs written into the smart contract. For example, a government payment can be sent from a domain node account 620 to a smart contract account 622 via a transaction on the distributed ledger 616. The smart contract codifies various KPIs and standards for meeting the KPIs and specifies that the government payment paid into the contract account is to be transferred to a domain node account of the performing party upon achievement of the specified KPIs.

The data trust system 600 may improve the quality of data available for analysis, for example via AI engine 620 of FIG. 6. The data trust system 600 smart contracts may provide the data producers with full transparency on how their data assets will be used and stored, which may ensure full digital rights.

In another example, the data trust system 600 may be used to support straight through processing (“STP”), such as an insurance context. STP is a mechanism used by companies to automate the flow of data across the entire lifecycle of a transaction.

STP involves the digital transfer of data across departments and stakeholders without the need for any manual rekeying, human intervention, or legal review. Companies streamline their operations as a result of more efficient processing, lower operating costs, and ultimately increased customer satisfaction. The proliferation of information technology has led to the broad adoption of STP across many industries. Financial services originally created the concept of STP to automate the flow of ownership rights and debt obligations between banks, brokers, and investors. Since then, merchants have adopted STP to automate the flow of transactions between their suppliers, stores/warehouse, and customers for fast and accurate reconciliation. Insurance firms have adopted STP to systematically review and process a large volume of claims.

While STP offers numerous advantages to modernizing a businesses processes, it also presents certain challenges to industries where fraud is prevalent. It is conservatively estimated that fraud amounts to $80 billion a year across all lines of insurance. Insurers must balance between efficiently processing a continuously large volume of claims while simultaneously verifying the claim to mitigate fraud. Current STP systems are derived from logic-based computing that streamline the flow of data but fail to flag subtle nuances indicative of fraud.

In an embodiment, the data trust system 600 may support an STP application that requires in-depth oversight. The data trust system 600 may include an AI-based data trust application.

As insurance claims pass through the data trust system 600, the system 600 uses AI, for example via AI engine 626, to autonomously analyze each claim against a plurality of fraud-indicating variables to verify the authenticity of the claim. Claims that comply with insurer requirements can be streamlined through the data trust system 600 for payment. Claims that do not comply with insurer requirements are flagged. Flagged claims can be regrouped for additional oversight and/or legal intervention.

The data trust system 600 may be configured to authenticate compliance, accuracy, and authenticity of the data assets transferred within the data trust 600 with the data trust grantors (data producers) and beneficiaries (data consumers). By doing so, the data trust system 600 can maintain the integrity of the assets 634 shared or transferred within the domain 604.

In another example, the data trust system 600 may be used to verify the identity and transaction history of clients. This may be performed, for example, as part of a know-your-customer (“KYC”) framework component of an anti money laundering (“AML”) procedure.

KYC is a component of AML procedures that provide a framework for businesses to verify the identity and transaction history of their clients. KYC requirements can differ from country to country based on federal, state or municipal regulations. These varying requirements are the responsibility of each financial institution or regulated company to ensure they have a complete understanding of a client's identity and their ongoing transactions in order to maintain compliance. The rapid growth of cross-border banking and innovative financial tools like cryptocurrencies have forced governments to constantly prioritize their regulatory framework to ensure AML policies sufficiently prevent nefarious financial transactions. AML regulators are competing with motivated actors such as terrorist organizations, organized crime and tax evaders that are constantly seeking new channels to circumvent government's oversight and controls. As such, AML frameworks are constantly evolving to adapt to continuous innovation within the financial sector.

International businesses often struggle to comply with AML and KYC regulations. This may be due to the complexity of requirements that differ across jurisdictions. A modern KYC solution is one that complies with cross border jurisdiction-specific regulations, while simultaneously protecting the data rights of the individuals who are submitting their sensitive data.

In an embodiment, the data trust system 600 can be used to support a KYC/AML protocol.

Individuals can submit their information as data assets 634 to the data trust domain 604 as a data producer 524.

The financial and/or regulated firms can serve as the beneficiary or data consumer 528 of the domain 604.

A trustee 516 of the domain 604 can set policies (e.g. policy data 636) that administer the appropriate KYC data to data consumers 528 (i.e. beneficiaries) so the data consumers 528 can automatically verify client information without permanently recording the data within their systems.

The data trust system 600 may allow customers to securely streamline their KYC data to multiple data consumers 528 while simultaneously maintaining the sovereignty of their sensitive data across jurisdictions.

The data trust system 600 may also analyze and report data that is flagged as suspicious to the permitted data consumers 528 including financial institutions, regulators and regional authorities.

The data trust systems and methods of the present disclosure may have advantages over existing techniques and approaches to managing and providing access to data assets shared between entities.

The data trust system 600 may distribute and decentralize control and ownership of data assets, providing a framework through which contributing entities in the data value chain and workflow have a voice.

The system 600 may enable enterprises to ensure and certify that data is used for the purposes it was intended for (i.e. to benefit the users). The system 600 may avoid forcing users to place considerable trust into certain organizations operating monolithic centralized systems. The system 600 may allow enterprise systems, methods, and applications to certify that data and data value flows in an intended way. The system 600 may include data trust applications that may ensure that data flow between all entities is secure, trusted, traceable, and scalable, and that the governance constructs and policies deemed necessary by those entities are enforced.

The data trust system 600 may address more than privacy or security of data. The data trust system 600 may provide a platform enabling control over the data assets for the partners within the data trust. The data trust system 600 may address concerns associated with data trusts and provide various advantages.

The data trust system 600 may enable control and flexibility in rules and guidelines. For example, the data trust system 600 may not be prescriptive in forcing a certain governance methodology. The governance methodology may be determined by the data trust itself (for example, via the trust parties).

The data trust system 600 may ensure value of open data is retained.

The data trust system 600 may enable representation of groups and individuals and ensure that such groups have a voice within the data trust domain 604.

The data trust system 600 may not force a data localization methodology. Data localization refers to where the data resides from a geography or jurisdictional perspective.

The data trust system 600 may support data assets remaining in place at their source, data moving to a cloud, or both. In fact, regardless of jurisdiction (i.e. in the case of USMCA, Canadian citizen data under purview of the US Patriot Act) the data trust system 600 may track this flow of data via a data trust pathway object.

The data trust system 600 may include a distributed framework allowing data assets to remain in place versus forcing a centralized data lake. This may enable greater flexibility in deployments and governance models.

The data trust system 600 may provide detailed data policies, access capabilities, and audit trails.

The data trust system 600 may enable data to flow easily between data producers and data consumers while adhering to policies. This may enable more real time “flow” of data versus static snapshots of data being shuffled around from and between data partners through an enforcer.

The data trust system 600 may provide advanced AI analytics capabilities, such as via AI engine 626, while leaving data in place.

The data trust system 600 may provide a value exchange system built into the data trust to value the data assets between data producers and data consumers. The value exchange system may use tokens that can be transferred to and from domain accounts 618.

The system 600 may have advantageous data management capabilities. The system 600 may allow onboarding of data partners with a centralized platform that provides full audit and compliance management. The system 600 may allow for definition of granular permissions and data rights management policies for a data partnership. The system 600 may enable control and ownership of data by partners, as determined by the policies created by trust parties. The system 600 may provide transparency on how data is shared and used by others in the trust. The system may monitor, trace and audit data asset exchange and AI activity while ensuring (GDPR) compliance.

The system may promote collaboration and sharing of intelligence across business units (e.g. CRM, ERP, PPM, HRM, Payroll Partners and Customers). The system 600 may help optimize internal practices, workforce management, and improve interactions between trustees, producers and customers.

The system 600 may be used to collaborate and share intelligence across organizations that require data sovereignty, such as government agencies and departments, international partners, academics, and researchers. The system 600 may allow data partners 520 to create their own data sharing domain 504 via data provider APIs and academic and research consumer APIs.

The system 600 may facilitate remuneration of trust parties 512 via secure transactions. The remuneration may be facilitated by tokens and smart contracts via domain accounts 618.

The system may advantageously deidentify data in data assets 634, which may alleviate or reduce privacy concerns associated with sharing data including identifiable information. Such deidentification or data anonymization may allow a user to leave its data in place.

While the above description provides examples of one or more apparatus, methods, or systems, it will be appreciated that other apparatus, methods, or systems may be within the scope of the claims as interpreted by one of skill in the art.

1. A method of sharing a data asset via a computer-implemented data trust, the method comprising:
creating, in response to a user input, a data trust domain, including instantiating a private network, the private network including a plurality of domain nodes, the domain nodes including a data producer node and a data consumer node, wherein the data asset is provided by the data producer node;
defining access rights for the data asset as between the data consumer node and the data producer node; and
creating a data pathway object, wherein the data pathway object specifies the access rights for the data asset, and wherein the flow of data within the data trust domain is controlled according to the data pathway object.

2. The method of claim 1, further comprising:
providing the data consumer node with access to the data asset according to the data pathway object, wherein the access is provided via the private network.

3. The method of claim 1, wherein the access rights include a permitted computation, the permitted computation including any one or more of a calculation, a model, and a computation which the data consumer node can perform on the data asset.

4. The method of claim 2, wherein the providing the data consumer node with access includes running a permitted computation according to the data pathway object, the permitted computation including any one or more of a calculation, a model, and a computation which the data consumer node can perform on the data asset.

5. The method of claim 1, further comprising:
assigning each of the domain nodes a domain node account, wherein the domain node account is an account on a distributed ledger, wherein the domain node account is controlled by the domain node assigned the domain node account, and wherein the domain node assigned the domain node account can initiate a transaction on the distributed ledger from the domain node account.

6. The method of claim 5, further comprising:
generating a synthetic account comprising an account on the distributed ledger, the synthetic account representing a plurality of entities each having a right to vote on policies of the synthetic account.

7. The method of claim 1, further comprising:
codifying, in a smart contract, the access rights specified in the data pathway object, and wherein the smart contract, when executed, controls access to the data asset.

8. The method of claim 1, further comprising:
accessing the data asset via an artificial intelligence engine communicatively connected to the data producer node.

9. The method of claim 1, wherein the data pathway object defines a network pathway along which data can travel.

10. The method of claim 1, wherein the data asset is generated during a machine learning lifecycle, and wherein the data asset comprises any one or more of a dataset, a derivative dataset, or a machine learning model.

11. The method of claim 1, wherein the data pathway object specifies that the data asset is to pass through a computational node configured to remove or obscure identifiable information.

12. The method of claim 1, wherein the data pathway object specifies any one or more of ownership, routing, storage, processing, and access for the data asset.

13. The method of claim 1, wherein the access rights include a data handling policy created based on metadata, and wherein the metadata includes any one or more of a data subject, a data source, a data format, a current and future identifiability of a data subject, a time of data acquisition, and a location of data acquisition.

14. The method of claim 1, further comprising:
codifying domain access rights in a smart contract which, when executed, controls whether a domain node can access the data trust domain.

15. A system for providing a computer-implemented data trust for sharing a data asset, the system comprising:
a data trust server including a processor configured to:
create a data trust domain in response to a user input, wherein the data trust domain includes a private network for communicatively connecting a plurality of domain nodes, the plurality of domain nodes including a data producer node and a data consumer node; and
create a data trust pathway object, wherein the data trust pathway object specifies access rights for the data asset as between the data producer node and the data consumer node, and wherein the flow of data within the data trust domain is controlled according to the data trust pathway object.

16. The system of claim 15, wherein the plurality of domain nodes are added to the data trust domain according to a domain access policy which is codified in a smart contract such that the smart contract, when executed, controls access to the data trust domain.

17. The system of claim 15, wherein the processor is further configured to assign a domain node account to each of the plurality of domain nodes, wherein the domain node account is an account on a distributed ledger, wherein the domain node account is controlled by the domain node assigned the domain node account, and wherein the domain node assigned the domain node account can initiate a transaction on the distributed ledger from the domain node account.

18. The system of claim 15, wherein the data trust pathway object defines a network pathway along which data can travel.

19. The system of claim 15, wherein the data pathway object specifies any one or more of ownership, routing, storage, processing, and access for the data asset.

20. The system of claim 15, wherein the access rights specified in the data pathway object are codified in a smart contract which, when executed, controls access to the data asset.
